(19) United States
(12) Patent Application Publication
(10) Pub. No.: US 2022/0164715 A1
(43) Pub. Date: May 26, 2022

(54) Open loop transit system with a backend system

(71) Applicant: Scheidt & Bachmann USA, Inc., Lowell, MA (US)

(72) Inventor: Manfred Troll, Mönchengladbach (DE)

(21) Appl. No.: 16/953,543

(22) Filed: Nov. 20, 2020

(51) Int. Cl. G06Q 10/02; G06Q 20/14; G01C 21/36; G08G 1/00

(52) U.S. Cl. CPC G06Q 10/02; G08G 1/202; G01C 21/3605; G06Q 20/145

(57) ABSTRACT

A backend system of an open loop transit system, includes at least one billing module configured to bill a completed trip at least based on a received start data set, a received end data set and a fixed preset tariff datum, wherein the start data set and the end data set each contains the same medium identification reference determined from the electronic medium identification of a ticket medium detected by at least one validator device and at least one transport information datum, at least one dynamic tariff determination module configured to determine a current tariff datum based on a requested trip datum and at least one tariff criterion, at least one output module configured to output the current tariff datum, and at least one storage module configured to store a journey data set containing the requested trip datum, the outputted current tariff datum and a medium identification reference.

### TECHNICAL FIELD

The application relates to a backend system of an open loop transit system, comprising at least one billing module configured to bill a completed trip at least based on a received start data set, a received end data set and a fixed preset tariff datum, wherein the start data set and the end data set each containing the same medium identification reference, determined (in particular, calculated) from the electronic medium identification detected by at least one validator device of the transit system, and at least one transport information datum. Furthermore, the application relates to an open loop transit system and a method for operating an open loop transit system.

### BACKGROUND ART

Transit systems for carrying out trips are known from the prior art. A trip in a transit system is understood, in particular, to be the use of a transport device, preferably a transit vehicle (e.g. bus, train, plane, watercraft, etc.), by a user. In other words, a transit system may comprise at least one transit vehicle for transporting users and persons, respectively.

In order to acquire a travel authorization in conventional (passenger) transit systems, a user can obtain the travel authorization, typically before the trip, for example, by purchasing a ticket. Exemplary and non-exhaustive travel authorizations for transit systems are single or multiple ride tickets as well as time-based tickets, such as weekly or monthly tickets.

Nowadays, transit systems and ticket systems, respectively, are also used in which ticket media with electronic user authorizations are used, such as electronic tickets. Usually, transit systems use proprietary ticket media of the provider of the transit system. A characteristic feature is hereby that these electronic ticket media have the validity information and usage information stored as data on the ticket medium (so-called card based ticketing). Typically, the card based ticketing is a “pre-paid” method in which the travel authorization is purchased in advance and encoded as electronic data on the ticket medium. Card based ticketing is a kind of electronic representation of the printed paper ticket with the validation imprint. These ticket media are primarily proprietary in that they have their own data content and/or data structure and/or data encryption for the transit system and/or for the provider of the ticket system.

However, in order to further increase user-friendliness, so-called open loop transit systems and transit systems with an open loop ticket system, respectively, are increasingly being implemented. In an open loop transit system, users can conduct trips using, in particular, a non-proprietary ticket medium.

In such transit systems, a travel authorization is an electronic medium identification of a (portable) ticket medium readable by a validator device, such as an electronic card identification of a ticket medium in the form of a credit card and/or debit card or an electronic identification of a payment service application installed on a mobile terminal of a user.

In principle, an authorized trip can be made by a user as follows: When the user enters a paid area (e.g. a transit vehicle, a platform of a take-off station, etc.), the electronic medium identification stored on the ticket medium can be detected by a validator device of the open loop transit system. The validator device can be installed at the at least one access (e.g. entrance and/or exit) to the paid area. In particular, a validator device may have at least one ticket medium interface, like a ticket medium reader, for example, in the form of a card reader. A ticket medium held on (with a sufficient range) or in the ticket medium reader can be read so that the electronic medium identification stored in a data storage of the ticket medium can be detected. In variants of the transit system it may be provided that a validator device is formed with at least one blocking element (e.g. as an access barrier or so-called “gate”) or without a blocking element (e.g. as a validator).

When leaving the paid area, a further or the same validator device of the transit system can detect the electronic medium identification stored on the ticket medium, as described above.

For billing of the completed trip, the at least one validator device can transmit the medium identification reference of the respective detected electronic medium identification in the form of a start data set or an end data set to a (central) backend system (e.g. formed by one or more distributed computing device(s)) of the transit system. Preferably, a start data set and an end data set can each comprise at least one transport information datum, such as a system-wide unique (one-to-one) identifier (in particular, an identification number) of the validator device and/or a respective detection time information and/or a detection location.

A billing module (e.g. implemented on a computing device of the backend system) of the backend system can, based on the medium identification reference (which can, in particular, include billing data, such as a hashed credit card number or the like) and the at least one transport information datum (e.g. the location information and/or time information) of the start data set and end data set, carry out a billing of the completed trip.

For example, the billing module can be configured to perform time-based and/or distance-based billing based on the received data.

In the backend system of an open loop system, which is known from the prior art, the billing is always based on at least one fixed preset tariff datum, i.e. an unchangeable tariff datum.

An open loop system therefore differs from the above described card based ticketing in that the open loop ticket media are non-proprietary (they are, for example, credit cards), that the open loop ticket media do not carry any tariff validity information and also no travel authorizations, but only an identification (for example, the ePAN, i.e., the electronically encoded credit card number), that the billing of the trip is conducted in a backend system using, in particular, a user account assigned to the identification, and that the payment is “post-paid”, i.e., the payment for the trip is made after the trip, since only then the trip data is known. Because of the billing with, in particular, the help of a user account, one also speaks of account-based ticketing.

Indeed, such an open loop transit system increases the user comfort, as users do not have to purchase ticket media before a trip, but can make the trip with a ticket medium that is regularly available anyway.

In contrast to conventional card based ticketing, however, open loop (or account-based) ticketing has the disadvantage, from the point of view of the transport authority, that it does not allow reservations to be made, since no travel authorization can be stored on the open loop ticket medium. However, transport companies have an urgent need, in particular, in highly utilized metropolitan regions, to control the utilization of their transit vehicles and/or to adapt transport capacities to the demand.

In addition, a too high utilization of a transit vehicle or other areas liable to pay has the disadvantage that infectious diseases, such as Covid-19, can be easily transmitted due to the short distances between users. There is therefore an overall need to expand the functional scope of an open loop ticketing system so that users can make reservations and be encouraged to do so.

Therefore, the object of the application is to provide a backend system of an open loop transit system, in which the disadvantages of the prior art are at least reduced and, in particular, the risk of a too high utilization of areas liable to pay is reduced.

### SUMMARY OF THE INVENTION

According to a first aspect of the application, a backend system of an open loop transit system comprises at least one billing module configured to bill a completed trip at least based on a received start data set, a received end data set and a fixed preset tariff datum. The start data set and the end data set each contains the same medium identification reference, determined from the electronic medium identification of a ticket medium detected by at least one validator device of the transit system, and at least one transport information datum. The backend system further comprises at least one dynamic tariff determination module configured to determine a current tariff datum based on a requested trip datum and at least one tariff criterion. The current tariff datum is different from the fixed preset tariff datum. The backend system comprises at least one output module configured to output the current tariff datum determined for the requested trip datum. The backend system comprises at least one storage module configured to store a trip data set containing the requested trip data set, the current tariff datum and an electronic medium identification reference, upon receipt of a confirmation data set in response to the current tariff datum outputted for the requested trip datum. The billing module is configured to bill the requested trip datum based on the stored trip data set at least upon a detection of a use of the trip data stored for the electronic medium identification reference.

In contrast to the prior art, by providing a backend system according to the application in an open loop transit system, in which a dynamic tariff determination module is provided, which, depending on a received usage request and at least one specific tariff criterion, determines a tariff datum currently valid for the requested trip, which can be accepted by a user for the trip, the disadvantages of the prior art and, in particular, the risk of a too high utilization of areas liable to pay are at least reduced. In particular, by the backend system, according to the application, an utilization control system can be provided, in which the capacity adjustment of the transport operation and the comfort of the users can be improved in an open loop transit system, and the risk of a transmission of an infectious disease (e.g. Covid-19) can be reduced, for example, by enabling a better compliance with distance rules between users.

The backend system, according to the application, serves for controlling and/or managing an open loop transit system, in particular, the utilization of the transit vehicles of the open loop transit system. A backend system can comprise one or more (distributed) computing device(s) and, in particular, serve as a server arrangement. On the backend system, (software) modules executable by a processor can be installed.

An open loop transit system, according to the application, is an open loop passenger transit system. Such a transit system usually comprises a plurality of transit vehicles, such as buses, trains, airplanes, watercraft, etc.

Here, an open loop transit system (also referred to as a transit system in the following) means a transit system in which (at least also) non-proprietary ticket media can be used for a regular trip. It goes without saying that an open loop transit system can also allow the use of proprietary ticket media.

A ticket medium in accordance with the application is, in particular, a portable medium with at least one readable data storage or storage means configured at least to store an electronic medium identification. Preferably, the ticket medium can be a card based ticket medium, such as a credit card based ticket medium and/or debit card based ticket medium. Preferably the ticket medium can be a credit card and/or debit card. The card based ticket medium can also be a mobile device on which a credit card and/or debit card is electronically mapped or to which a credit card and/or debit card is electronically (uniquely) linked. Non-exhaustive examples of such a concept are Apple Pay, Google Pay or PayPal.

Exemplary and not exhaustive mobile terminals are smartphones, tablet computers, mobile game consoles, laptops, netbooks, data glasses, smart watches and similar wearables.

An electronic medium identification means, in particular, that it is stored in its entirety in the data storage of the ticket medium. In particular, a ticket medium interface, e.g. with a (contactless or contact-based) interface, is required to detect the electronic medium identification. If the ticket medium is, for example, a contactless credit card, the electronic medium identification is the “electronic Primary Account Number” (EPAN) of this card. The ePAN usually consists of the “Primary Account Number” (PAN), which corresponds to the printed or embossed card number, and a card sequence number, which identifies the individual card.

The (contactless or contact-based) interface for reading corresponds to the interface of the ticket medium. Non-exhaustive examples of contact-based ticket medium interfaces are magnetic stripes and Europay Mastercard VISA chips (EMV chips); examples of contactless ticket medium interfaces are nearfield communication interfaces (NFC interfaces) according to ISO 14443. For the above-mentioned example of the electronic credit card, the ePAN, i.e. the medium identification, can be read contactlessly via this interface.

Furthermore, according to the application, the electronic medium identification is a (system-wide) unique (one to one or bijective) electronic medium identification. This means, in particular, that a ticket medium can be uniquely identified (system-wide) by this medium identification. In particular, an electronic medium identification for credit cards and/or debit cards enables a differentiation between different card individuals who each have the same credit card number, but different electronic medium identifications. However, the credit card number can be determined from the respective electronic medium identification. Different card individuals can be, for example, partner cards (same credit card number for different users) or follow-on cards (expired and new credit card for the same user).

According to a preferred embodiment, the electronic medium identification can be an electronic Primary Account Number (ePAN). The ePAN contains the known readable PAN printed, embossed or engraved on a debit card or credit card, plus additional coded data, such as the card sequence number, which identifies the individual card.

The ePAN must therefore be read electronically from the card and is not human-readable.

In particular, the ePAN uniquely (one to one) identifies ticket media, such as individual credit cards and/or debit cards and/or (previously described) mobile terminals. The ePAN can be used to determine the country, credit institution, bank code and/or account number, in particular, with the aid of databases. In a simple way, a billing of a trip can be made possible.

According to the application, the backend system comprises at least one billing module to bill (in particular, in a conventional way) a completed trip, based on received start and end data sets. Each start data set and each end data set contains a medium identification reference, which allows the assignment of a start data set to an end data set. In particular, a start data set and an end data set are assigned to each other if they have identical medium identification references. A start data set is generated, in particular, at the start or beginning of a trip, for example, when entering a paid area, such as a transit vehicle, a station area, etc. An end data set is generated, in particular, at the end of a trip, for example, when leaving a paid area, such as a transit vehicle, a station area, etc. In their data structure, start data sets and end data sets can be identical.

The medium identification reference in a start data set or end data set is a value that is determined, in particular, calculated from the medium identification of the used open loop medium. In a simple case, the medium identification reference can be identical to the medium identification. In the application of the Payment Card Industry Data

Security Standard (PCI DSS), the medium identification reference is typically a hash value of the medium identification, e.g. the hash value of an ePAN.

In particular, the transit system may comprise a plurality of validator devices. A validator device is a device of a transit system that is used to detect the regular trip by a user. A validator device may, for example, be located at an access (e.g. entrance and/or exit) to a paid area. Entering this area is, in particular, equivalent to performing a trip. The paid area can be, for example, the interior of a transit vehicle, or a (delimited) area providing access to a transit vehicle, such as a railway platform or the like.

A detecting of the trip by a validator device includes, in particular, a detecting of the electronic medium identification of a ticket medium, for example, in course of a log in process (“check-in”) and/or log out process (“check-out”). For example, for a regular trip it is necessary for the user to log in (“check-in”) in the transit system when entering the paid area, in particular, by detecting at least one electronic medium identification in the course of a log in process by the validator device.

Accordingly, it may be necessary for the user to log out of the transit system (“check-out”) when leaving the paid area, in particular, by detecting at least one electronic medium identification in the course of a log out process by the validator device.

Hereby, an optional access barrier can be provided at the access, which in cooperation with the validator device (in the conventional way) releases and/or blocks the access.

In addition, the start data set and the end data set, respectively, is transmitted, by the validator device, to the backend system (which is remotely located from the validator device). The at least one validator device and the backend system can be connected via at least one (wireless and/or wired) communication network. The transmission of the data sets is preferably conducted in an encrypted manner. In other words, the validator device can encrypt a data set and the backend system can decrypt it again.

A data set (start data set or end data set) also contains at least one transport information datum. The at least one transport information datum is, in particular, an indication that enables a (time based and/or distance based) billing of the completed trip.

According to an embodiment of the backend system according to the application, at least one transport information datum can be selected from the group, comprising:
a time stamp of the detection of the electronic medium identification by the validator device,
an identification of the validator device (which has detected the electronic medium identification),
a location of the validator device (during the detection of the electronic medium identification),
an identification of a transit vehicle of the validator device,
an identification of a transport station (e.g. station, stop) of the validator device.

Preferably, a data set (start data set or end data set) can contain a time information, in particular in the form of a time stamp. The time stamp (e.g. calendar date and time) may, in particular, indicate the time of detection of the medium identification by the validator device. In case of a start data set, the time stamp represents, in particular, the beginning of a completed trip and in case of an end data set, the time stamp represents, in particular, the end of a completed trip.

Alternatively, or preferably in addition, a data set (start data set or end data set) may comprise a position information and location information, respectively, of the validator device (which detects the medium identification). A position information and location information, respectively, means, in particular, an information from which the location and installation position, respectively, of the validator device can at least be derived, i.e. the location at the time of the detection of the medium identification. For example, the location information can include an identification of the validator device, from which the location of the validator device can be derived with the help of a location database. Alternatively or additionally, the location information can include geographic position data (e.g. GPS coordinates).

In particular, in the case of mobile validator devices, i.e. those installed in transit vehicles, the location can be determined from infrastructure available on board; alternatively, the location can also be determined from the time stamp and the data of the operational management of the transit system in the backend system.

In the case of a start data set, the location represents, in particular, the start point and start station, respectively, of a trip and in the case of an end data set, the location represents, in particular, the end point and destination station, respectively, of a trip.

The billing module is configured bill the completed trip based on a start data set and an end data set that can be assigned via the respective medium identification reference. In particular, a generation of a billing data set can be conducted by the billing module. The billing data set can be generated, in particular, for billing purposes and then outputted by the backend system (to the corresponding user).

According to the application, the backend system comprises a dynamic tariff determination module configured to dynamically determine a current tariff datum based on at least one (predefined) tariff criterion and a requested trip datum. The current tariff datum is different from the fixed preset tariff datum. In particular, according to the application, a distinction is made between a static tariff datum, i.e. the fixed preset and, in particular, unchangeable tariff datum, and a dynamic tariff datum, i.e. a current and, in particular, changeable tariff datum.

In particular, requested trip datum indicates a trip that will (potentially) be performed by a user. It therefore refers to a trip that will be taken in the future (and therefore not immediately).

According to an embodiment of the backend system according to the application, the requested trip datum can comprise at least one trip datum selected from the group, comprising:
a start location of the requested trip,
a destination location of the requested trip,
a calendar date of the requested trip,
a start time point of the requested trip,
an end time point of the requested trip,
an identification assigned to a requested transit vehicle.

The at least one trip datum can uniquely (one to one) identify the requested trip (system-wide).

A start location represents, in particular, the location where the trip is started, i.e.

where the user enters a paid area. A destination location represents, in particular, the location where the trip will end, i.e. where the user (finally) leaves a paid area.

The calendar date is, in particular, the (scheduled) day of the requested trip.

The start time point is, in particular, the (scheduled) departure time point of a specific transit vehicle from a specific starting location of the requested trip, i.e. in particular, a specific start stop and a specific start station, respectively.

The end time point is, in particular, the (scheduled) arrival time point of a specific transit vehicle at a specific destination location of the requested trip, i.e. in particular, a specific end stop and a specific end station, respectively.

Furthermore, a transit vehicle can have a unique (one to one) identification (system-wide). For a unique identification of a specific and desired trip, the requested trip datum can preferably contain a start location and a destination location and at least one of a start time point and an end time point.

In particular, possible start time points and end time points for a requested trip can be offered to the user automatically for selection based on a stored timetable as soon as the start location, destination location and calendar date of the requested trip are entered.

The at least one tariff criterion means, in particular, a utilization control criterion with which the utilization of a paid area can be influenced at least potentially. The tariff criterion has, in particular, a relationship to the requested trip datum and to the fixed preset tariff datum. Depending on an evaluation of this relationship, the tariff determination module determines, in particular, a current tariff datum.

For example, the tariff criterion can specify that the current tariff datum (e.g., an amount of money to be paid for the requested trip) is less than the fixed preset tariff datum (e.g., also an amount of money to be paid for the requested trip) if a low utilization is predicted for the requested trip, at least at the time of receiving the usage request.

In particular, the tariff criterion can be such that the lower the utilization of the transit vehicle to be used is forecast, the lower the current tariff can be determined.

Conversely, the tariff criterion can be selected in such a way that the current tariff datum (e.g. an amount of money to be paid for the requested trip) is greater than/equal to the fixed preset tariff datum (e.g. also an amount of money to be paid for the requested trip), if a high utilization is at least predicted for the requested trip.

It goes without saying that a minimum tariff limit and/or a maximum tariff limit, e.g. the fixed preset tariff datum, is/are specifiable.

A current tariff datum means, in particular, a tariff datum which has only a limited temporal validity. The length of the validity period can be predefined (e.g. max. 30 min, 15 min, 5 min, 30 sec, 10 sec etc.).

In variants of the application, the validity period can be variable and dynamically, respectively, preset depending on at least one time criterion (e.g. number of requests received from different users in a specific time window, current time of day, etc.).

The backend system comprises an output module configured to output the current tariff datum for the requested trip datum. In particular, the determined current tariff datum can be outputted to the requesting entity (in particular, to the user terminal of the user).

In addition, the backend system comprises a storage module configured to store a trip data set containing the output current tariff datum, the requested trip datum and a medium identification reference upon receipt of a confirmation data set in response to the current tariff datum outputted for the requested trip datum. The medium identification reference may preferably be contained in the confirmation data set. It goes without saying that it can also be transmitted, alternatively or additionally, in another message or determined from a user account. The confirmation data set indicates at least implicitly that the user accepts the outputted current tariff datum and will do the requested trip at the outputted current tariff.

By (temporarily) storing the trip data set, it can be ensured that for a subsequent use of the requested trip the outputted and stored current tariff datum is applied and not the fixed preset tariff datum.

According to the application, the billing module is configured to bill the requested trip datum based on the stored trip data set, at least in case of a detection of a use of the trip data stored for the medium identification reference. In other words, if it is detected that the requested trip has actually been completed as requested, a corresponding billing can be made. In the case of variants of the application, a billing can always be made, regardless of a determination that the requested trip was actually completed as requested.

In accordance with a further embodiment of the backend system according to the application, the backend system may further comprise:
at least one receiving module configured to receive a usage request from a user terminal, wherein the usage request comprises at least the requested trip datum, and/or
at least one receiving module configured to receive a usage confirmation from a user terminal, containing the confirmation data set.

A receiving module can comprise a communication interface to a (wireless and/or wired) communication network.

For example, a receiving module can be a web interface that allows a user to send a usage request to the backend system. In other variants of the application, a receiving module may be configured to receive and/or process transmitted messages.

A usage request contains at least the previously described trip datum. Optionally, a usage request can contain further data, such as a medium identification reference, and/or possibly further user data, such as a user name, address data of the user, etc.

Alternatively, or preferably in addition, the receiving module can be configured to receive a usage confirmation from a user terminal containing the previously described confirmation data set.

A user terminal can be a mobile terminal, as described above, or a stationary terminal, such as a stationary personal computer or the like.

According to a preferred embodiment of the backend system according to the application, the medium identification reference can be a medium identification reference registered in the backend system. A registered medium identification reference can be stored in a user data set in the backend system. The user data set may comprise at least one additional user datum selected from the group, comprising
a user name,
address data of the user,
a user password,
billing data,
trip tariff data,
account details,
data of other payment media,
a membership to a user group.

The operation of the transit system can be simplified and, in particular, made more comfortable for a user if a user is registered in the transit system. Registration in this case means, in particular, that the ticket medium used for the trips is registered, i.e., in particular, that a user data set (for example in the form of a user account) is created which contains at least the medium identification reference of the ticket medium of the user. Preferably, further user data may be contained.

If a user data set and user account, respectively, exists, the storage module can be configured to store the trip data set in the user account or at least provide a link to it.

In accordance with a further embodiment of the backend system according to the application, the backend system may further comprise:
at least one assignment module configured to assign a received end data set to a stored trip data set, based on the respectively contained medium identification reference, and
at least one check module configured to check whether the at least one transport information datum of the end data set corresponds to the stored trip datum of the trip data set (if an assignment between the mentioned data sets could be made).

When an end data set is received, the medium identification reference can be extracted from this data set. Then the assignment module can search for a stored trip data set containing this medium identification reference. If a trip data set can be identified by the assignment module, the data sets are assigned accordingly.

Afterwards, it can be checked by the check module whether the trip was actually completed as requested. For this purpose, the check module can at least check whether the at least one transport information datum (e.g. the destination station (e.g. derived from the validator identification) and the time stamp of the detection of the electronic medium identification by the validator device) of the end data set corresponds to the stored trip datum (e.g. destination station and end time point). If, for example, the location information (e.g. station information) is identical and the time information is at least within a given tolerance range (a possible delay of a transit vehicle can also be taken into account here), then it can be determined that the trip was actually completed as requested. If, however, a deviation is detected, i.e. if the at least one transport information datum of the end data set does not correspond to the stored trip datum, the trip was not completed as requested.

It shall be noted that a start data set and an end data set can basically be formed in the same way. Furthermore, it shall be noted that the assignment module may be additionally configured to search for a corresponding start data set when receiving an end data set. If no start data set and no trip data set are available, it can be concluded that the received data set is a start data set.

Optionally (but also alternatively) it can be provided that at least one assignment module is configured to assign a received start data set to a stored trip data set, based on the respectively contained medium identification reference. At least one check module can be configured to check whether the at least one transport information datum of the start data set corresponds to the stored trip datum of the trip data set (if an assignment between the mentioned data sets could be made), in particular, in an analogous way to check an assigned end data set. By assigning and checking both a start data set and an end data set, it can be ensured with even greater security that a user has completed a trip as requested (and, for example, has not previously boarded and/or later left a transit vehicle).

In accordance with a further preferred embodiment of the backend system according to the application, the billing module can be configured in such a way that the requested trip datum is only billed according to the stored current tariff datum if the check module determines that the at least one transport information datum (of the end and/or start data set) corresponds to the stored trip datum of the trip data set. This ensures that a user only has to pay a changed (in particular, lower) amount (compared to the fixed preset (standard) tariff datum) if the user has actually completed the trip as requested. Otherwise, billing can be based on the fixed preset tariff datum or a combination of the fixed preset and the stored current tariff datum.

In accordance with a particularly preferred embodiment of the backend system according to the application, the confirmation data set can replace the start data set, i.e., in particular, the log in process at a validator device. This further improves the user-friendliness. Thus, the user can enter a paid area without a previously described log in. The log in itself is done by outputting the confirmation data set. In other words, a web log in can be made. Only when leaving a paid area a previously described log out (and thus the generation of an end data set) may be necessary.

As already described, the at least one tariff criterion can preferably be a utilization control criterion and can in particular serve to control the utilization of the at least one transit vehicle of the transit system.

According to an embodiment of the backend system according to the application, at least one tariff criterion can be a time difference criterion. The time difference criterion can indicate a dependency between a time difference and the current tariff datum, where the time difference is, in particular, the time difference between the time point of receipt of a (previously described) usage request by the backend system and a start time point of the requested trip.

Preferably, the time difference criterion can be in the form of a time difference table. This table can cite the time difference between the time point the usage request is received and a (scheduled or actual) start time point of the requested trip. A current tariff datum can be assigned to each time difference value and time difference range, respectively. An example of a time difference table is shown in Table 1 below.

TABLE 1

| Time difference between the time | |
|---|---|
| point of receipt of the usage request | Current tariff datum |
| and a start time point of the | (in % depending on the |
| requested transit vehicle | fixed tariff datum TD_{F}) |
| Greater than 1 day | −15% |
| 24 h to 12 h | −10% |
| 12 h to 3 h | −5% |
| 3 h to 1 h | 0 |
| 1 h to 0 h | +2% |

It shall be understood that a table is only an example (e.g. the criterion can be in the form of a mathematical function) and/or a table can contain other entries (e.g. absolute amounts, other time difference ranges).

The dynamic tariff determination module can be configured to determine the time difference between the time point of receipt of the usage request and a scheduled start time point or actual start time point (which takes into account a possible already existing delay of the transit vehicle) of the requested trip when receiving a usage request. Then the current tariff datum can be determined depending on the determined time difference and the time difference criterion (e.g. the time difference table).

With respect to table 1, the dynamic tariff determination module determines a current tariff datum TD_{A}=0.85 *TD_{F} for a time difference of 15 h, a current tariff datum TD_{A}=TD_{F} for a time difference of 2 h, and for example, a current tariff datum TD_{A}=1.02 *TD_{F} for a time difference of 0.5 h. Here TD_{F} is the fixed preset tariff datum. By means of a corresponding criterion the utilization of a transit vehicle can be detected at an early stage and this can be taken into account in the utilization control.

In accordance with a particularly preferred embodiment of the backend system according to the application, at least one tariff criterion can be a transport utilization criterion. The transport utilization criterion can indicate a dependency between the transport utilization of at least one transit vehicle and the current tariff datum. The dynamic tariff determination module can preferably be provided with a predicted and/or measured utilization of a transit vehicle of the requested trip.

The transport utilization criterion can preferably be in the form of a transport utilization table. This table can cite the difference between the transport utilization and a full utilization and maximum transport capacity, respectively, of the transit vehicle. A current tariff datum can be assigned to each transport utilization value and transport utilization range, respectively. An example of a transport utilization table is shown in table 2 below.

TABLE 2

| Difference between the transport | Current tariff datum |
|---|---|
| utilization and a full utilization | (in % depending on the |
| of the requested transit vehicle | fixed tariff datum TD_{F}) |
| Smaller than 40% | −15% |
| 40% to 60% | −10% |
| 60% to 80% | −5% |
| 80% to 95% | 0 |
| 95% h to 110% | +2% |

It shall be understood that a table is only an example (e.g. the criterion can be in the form of a mathematical function) and/or a table can contain other entries (e.g. absolute amounts, other ranges).

In particular, the backend system according to the application may include at least one utilization determination module configured to determine the utilization of a transit vehicle.

For example, a database with historical utilization data of transit vehicles can be provided in the backend system. Based on the historical utilization data, the utilization determination module can determine the utilization of a transit vehicle, in particular, predict it. Here an AI (artificial intelligence) technology can be used.

Alternatively or additionally, the load determination module can be configured to determine the utilization of a transit vehicle based on the actual start data sets available for this transit vehicle, i.e. the number of users actually logged in to this transit vehicle. The transport capacity of the transit vehicle can be known to the utilization determination module (in particular, from a corresponding database of the backend system). Preferably additionally, but also alternatively, the determination of the utilization of the transit vehicle can be based on the stored trip data sets actually available for this transit vehicle. This way, the utilization of a transit vehicle can be determined precisely and in a simple way.

In other variants of the application, alternatively or additionally, at least one other or further datum can be considered, such as a number of persons detected by at least one sensor (e.g. camera with image evaluation module, passage counting unit of a gate etc.), which is relevant for a transit vehicle, number of received usage requests for a specific trip (e.g. within a specific time period) etc.

The dynamic tariff determination module can be configured to query a provided and determined (predicted and/or measured) utilization of the requested transit vehicle upon receipt of a usage request (preferably, the transit vehicle may be (uniquely) determined from the content of the usage request). Then the current tariff datum can be determined depending on this utilization and the transport utilization criterion (e.g. the transport utilization table).

With regard to table 2, the dynamic tariff determination module determines a current tariff datum TD_{A}=0.9 *TD_{F} for a (predicted and/or measured) utilization rate of 50%, a current tariff datum TD_{A}=TD_{F} for a (predicted and/or measured) utilization rate of 85% and, for example, a current tariff datum TD_{A}=1.02 *TD_{F} for a (predicted and/or measured) utilization rate of 100%.

Alternatively or additionally, according to a further embodiment of the backend system according to the application, at least one tariff criterion can be a meteorological criterion. For example, it can be determined in advance how specific meteorological conditions/criteria (e.g. temperature, wind speed, probability of precipitation, type of precipitation (e.g. snow, rain, hail) etc.) affect the utilization of transit vehicles.

If, for example, it is determined that the utilization of a transit vehicle is lower for a first meteorological condition than for a second meteorological condition, the first meteorological condition can be assigned with a lower current tariff datum than the second condition (different from the first meteorological condition). The meteorological criterion can also be in tabular form. An exemplary table is the following table 3.

TABLE 3

| | Current tariff datum |
|---|---|
| | (in % depending on the |
| Meteorological condition | fixed tariff datum TD_{F}) |
| First condition (e.g. temperature | −15% |
| between 10 and 20° C.; probability of | |
| precipitation between 0% and 20%, | |
| precipitation type: rain) | |
| Second condition (e.g. temperature | +2% |
| between −5 and 5° C.; probability of | |
| precipitation between 0% and 20% | |
| Precipitation type: snow, sleet) | |
| Third condition (e.g. temperature | +5% |
| between 20 and 30° C.; probability of | |
| precipitation between 70% and 100%, | |
| type of precipitation: rain, | |
| thunderstorm, etc.) | |

It goes without saying that a table is only an example (e.g. the criterion can be in the form of a mathematical function) and/or can contain other entries (e.g. absolute amounts, in particular a multitude of conditions).

The dynamic tariff determination module can be configured to query a provided (predicted and/or measured) meteorological condition for the requested trip (i.e. during use and for the location of use) upon receipt of a usage request. Then, depending on this meteorological condition and the meteorological criterion (e.g. the meteorological condition table) the current tariff datum can be determined.

With regard to table 3, the dynamic tariff determination module determines a current tariff datum TD_{A}=0.85 *TD_{F} for a first meteorological condition, a current tariff datum TD_{A}=1.02 *TD_{F} for a second meteorological condition and, for example, a current tariff datum TD_{A}=1.05 *TD_{F} for a third meteorological condition.

In accordance with a further embodiment of the backend system according to the application, the at least one tariff criterion can be at least one event criterion. An event occurring during (or even shortly before or after) the period of the requested trip can have an influence on the utilization of a transit vehicle.

For example, it can be determined in advance how specific local events and/or specific global events (e.g. local soccer league game, (global, i.e. taking place away from the location of the transit system) soccer world championship game, local demonstration, local trade fair, etc.) affect the utilization of transit vehicles.

For example, if it is determined that for a first event a utilization of a transit vehicle is lower than for a second event, the first event can be assigned with a lower current tariff datum than the second event (different from the first event). The event criterion can also be in tabular form. An exemplary table is the following table 4.

TABLE 4

| | Current tariff datum |
|---|---|
| | (in % depending on the |
| Event condition | fixed tariff datum TD_{F}) |
| First event | −10% |
| Second event | 0 |
| Third event | +2% |

It goes without saying that a table is only an example (e.g. the criterion can be in the form of a mathematical function) and/or can contain other entries (e.g. absolute amounts, further events).

The dynamic tariff determination module can be configured to query events that fall within the period of time of the requested trip when a usage request is received. Then, depending on the specific event and the event criterion (e.g. an event table) the current tariff datum can be determined.

With regard to table 4, the dynamic tariff determination module determines a current tariff datum TD_{A}=0.9 *TD_{F} for a first event, a current tariff datum TD_{A}=TD_{F} for a second event and, for example, a current tariff datum TD_{A}=1.02 *TD_{F} for a third event.

Preferably, at least two of the above mentioned tariff criteria may be predefined and, in particular, may have a specific functional relationship to each other. The determination of the current tariff datum by the dynamic tariff determination module can be based on two or more tariff criteria and according to the specific functional (e.g. weighted) relationship between these criteria. The utilization control can be further improved.

In accordance with a further embodiment of the backend system according to the application, the backend system may further comprise:
at least one blocking check module configured to check whether an amount to be paid for the completed trip has been paid within a specific period of time, and
at least one blocking module configured to send a blocking message to the at least one validator device such that the use of the ticket medium at the at least one validator device is blocked.

In particular, in order to prevent or at least impede further trips, if the user has not paid the amount to be paid for the completed trip within a specific period of time or if the ticket medium is not (no longer) permitted for other reasons (e.g. an overdraft of a credit limit), a blocking message can be sent to preferably all validator devices of the transit system. The blocking message can at least contain the medium identification and medium identification reference, respectively, to be blocked. This can be stored in a local data storage of the at least one validator device.

Before an access to a paid area is released, e.g. by means of a passage barrier, the detected medium identification can be checked, for example, by means of a comparison operation. If it is determined that this corresponds to a stored (inadmissible) medium identification reference, access can remain blocked. It is also possible to indicate on a display unit of the validator device that the (desired) trip must not be made with the ticket medium used. Then further measures can be initiated.

Another aspect of the application is an open loop transit system, comprising:
at least one backend system previously described, and
at least one (previously described) validator device configured to detect an electronic start data set and/or end data set of a ticket medium used for a trip.

Detecting an electronic start data set and/or end data set comprises, in particular, a detection of an electronic medium identification and medium identification reference, respectively, and at least one transport information datum, in particular, in the form of the detection time (and/or the detection location). As described, a start data set and/or end data set can be transmitted to the backend system, in particular, immediately after the detection.

In accordance with a preferred embodiment of the transit system according to the application, the transit system may further comprise:
at least one service application installable on a (mobile) user terminal,
wherein the service application comprises at least one request module configured to cause a sending of a usage request containing at least one requested trip datum, and/or
wherein the service application comprises at least one receiving module configured to receive a current tariff datum determined for the requested trip datum, and/or
wherein the service application comprises at least a confirmation module configured to cause a sending of a usage confirmation containing at least one confirmation data set.

In particular, the service application is a software application that can be installed on a (mobile) user terminal and executed by a processor of the user terminal. The transit system may include at least one (mobile) user terminal with a service application.

The service application in the form of a computer program, in particular, the instructions and program instructions, respectively, may be stored in a computer program product, in particular, a program memory. For example, a program memory is a non-volatile memory such as a flash memory, a magnetic memory, an EEPROM memory (electrically erasable programmable read-only memory) and/or an optical memory.

In addition, a (mobile) user terminal may have a main memory, for example a volatile or non-volatile memory, in particular, a random access memory (RAM), such as a static RAM memory (SRAM), a dynamic RAM memory (DRAM), a ferroelectric RAM memory (FeRAM) and/or a magnetic RAM memory (MRAM). For example, the processor of the user terminal can store intermediate results or similar in the main memory.

For interaction with the backend system (via a communication network), the service application may have at least one (software) module.

A request module is configured to cause a transmission of a previously described usage request to the backend system. A receiving module is configured to receive an outputted current tariff datum. A confirmation module is configured to send a previously described usage confirmation to the backend system. An interaction between a user and the service application can take place via a user interface of the user terminal.

A further aspect of the application is a method for operating a (previously described) open loop transit system, comprising at least one backend system, in particular, a previously described backend system (according to one of the previous claims), characterized in that the method comprises:
determining, by a dynamic tariff determination module of the backend system, a current tariff datum based on a requested trip datum and at least one tariff criterion,
outputting, by at least one output module of the backend system, of a current tariff datum determined for the requested trip datum,
upon receipt of a confirmation data set in response to the current tariff datum outputted for the requested trip datum: storing, by at least one storage module of the backend system, a trip data set containing the outputted current tariff datum, the requested trip datum and a medium identification reference of the confirmation data set, and
upon a detection of a use of the trip datum stored for the medium identification reference: billing, by a billing module of the backend system, of the requested trip datum, based on the stored trip data set.

A previously described module, element, etc. may at least partially comprise hardware elements (e.g. processor, storage means, etc.) and/or at least partially comprise software elements (e.g. executable code). It should also be noted that terms such as “first”, “second”, etc. do not indicate a sequence, but serve in particular to distinguish between two elements (e.g. terminal, module, condition, event etc.).

The features of the backend systems, open loop transit systems and methods can be freely combined. In particular, features of the description and/or the dependent claims, even by completely or partially circumventing features of the independent claims, may be independently inventive, either alone or freely combined with each other.

There is now a plurality of possibilities to design and further develop the backend system according to the application, the method according to the application and the open loop transit system according to the application. For this purpose, reference is made on the one hand to the patent claims subordinate to the independent patent claims, and on the other hand to the description of embodiments in connection with the drawing.

### BRIEF DESCRIPTION OF THE DRAWINGS

The drawings include:

FIG. 1 a schematic view of an embodiment of an open loop transit system according to the present application with an embodiment of a backend system according to the present application,

FIG. 2 a diagram of an embodiment of a method according to the present application, and

FIG. 3 a diagram of a further embodiment a method according to the present application.

### DETAILED DESCRIPTION OF SPECIFIC EMBODIMENTS

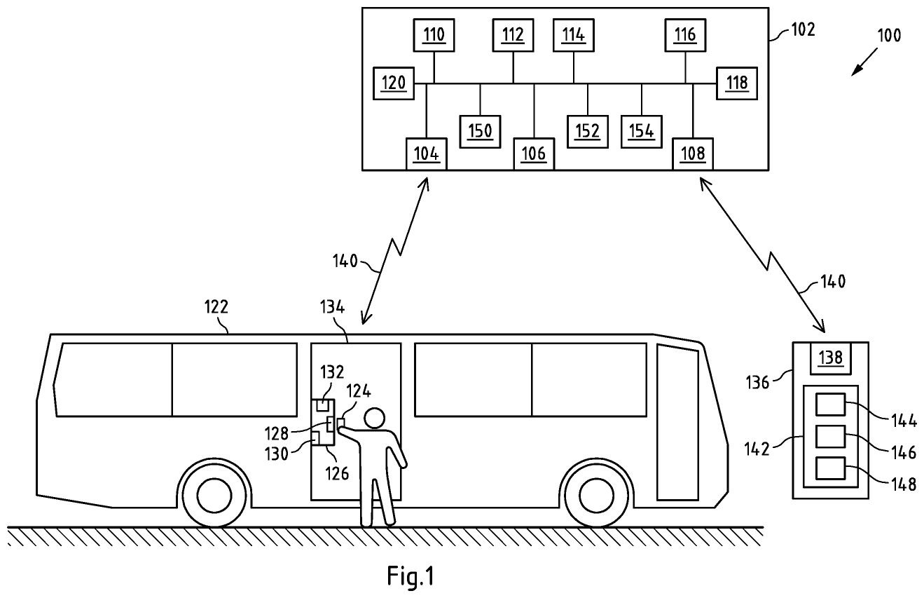

FIG. 1 shows a schematic view of an embodiment of an open loop transit system 100 (or a transit system 100 with an open loop ticket system) according to the present application with an embodiment of a backend system 102 according to the present application.

The presented transit system 100 comprises at least one backend system 102 and at least one validator device 126. In addition, the transit system 100 comprises at least one transit vehicle 122, in this example in the form of a bus 122. It shall be understood that a transit system 100 can, alternatively or additionally, comprise further and/or other transit vehicles (e.g. cable car, railroad vehicle, water vehicle etc.).

In this example, at least one validator device 126 is located in the transit vehicle 122. As can be seen, the at least one validator device 126 is located at an access 134 (e.g. entrance and/or exit) of the transit vehicle 122 to a paid area, preferably the interior of the transit vehicle 122. Preferably, at least one validator device 126 can be located at each access 134 of a transit vehicle 122. In other variants of the application, the validator device may also be located in a station or the like.

When operating the transit system 100, a user of transit vehicle 122 can log in (“check-in”) for an authorized trip when entering the transit vehicle 122. For this purpose, the user can bring his ticket medium 124, in particular, within reach of a ticket medium interface 128 of the validator device 126.

The at least one ticket medium interface 128 can be a contact or contactless ticket medium interface 128. It shall be understood that two or more ticket medium interfaces may be provided for a corresponding number of different ticket media.

In particular, the ticket medium interface 128 allows at least one electronic medium identification datum of the ticket medium 124 to be detected in the log in process. In this example, the ticket medium 124 is a credit card 124 with an ePAN stored in a data storage of the credit card 124. This can be detected via a (contact or contactless) interface of the ticket medium 124.

It goes without saying that in other variants of the application other ticket media can be used alternatively or additionally, as already described.

The validator device 126 may comprise at least one communication module 132 and/or be connectable to at least one (not shown) communication module of the vehicle infrastructure. The communication module 132 can at least be configured to transmit a medium identification reference of the detected electronic (unique) medium identification and at least one transport information datum, preferably together with further data, to the (central) backend system 102 of the transit system 100. In particular, a corresponding data set is transferred, such as a (previously described) start data set or end data set.

The at least one transport information datum of a start data set or end data set can, in particular, be a time stamp (e.g. calendar date and time of the detection time point) and/or at least one location information datum from which the location of the validator device (and the transit vehicle 122, respectively) can at least be derived during the detection of the electronic medium identification.

Optionally, the validator device 126 can comprise at least one local data storage 130. The at least one data storage 130 can store a list of blocked and unauthorized, respectively, medium identification references. When the electronic medium identification is detected, the medium identification reference can be calculated and compared to the stored and blocked medium identification references. If a correspondence (in particular, identity) is detected, the trip can be refused.

On a (not shown) display unit of the validator device 126 it can, alternatively or additionally, be indicated that the ticket medium 124 is not authorized for the regular use of the transit vehicle 122, likewise the validator device 126 can indicate the refusal of the trip with an acoustic signal.

In other variants of the application, an additional access device (e.g. a passage barrier) may be provided. This can only be released if it is determined during the matching process that the detected electronic medium identification is not a blocked medium identification.

When leaving the transit vehicle 122, the user can log out (“check-out”), in particular, in an analogous way to the log in process described above. In a corresponding manner, a validator device (e.g. the same validator device 126) can transmit at least the medium identification reference and at least one transport information datum, preferably together with the other data mentioned, to the backend system 102. In particular, a transmission of an end data set is conducted.

In the case of an inspection by an inspector, the inspector may use an inspection device (not shown) to retrieve, in particular receive, the medium identification references transmitted to the backend system 102 and use them for the inspection. In particular, the inspection device can check the ticket media by reading the respective medium identification, calculating the medium identification reference from it and comparing it with the medium identification references received from the backend system 102. If it is found that a user has not logged in and/or has a ticket medium with a blocked medium identification, the inspector can take known measures.

The backend system 102 can be formed by one or more (possibly distributed) arranged computing device/s. The backend system 102 comprises a plurality of modules. These can be at least partly formed as software modules and/or hardware modules.

As already described, a communication module 132 of the validator device 126 can exchange data with a communication module 104 of the backend system 102 (preferably bidirectional).

In addition, the backend system 102 comprises an output module 106 and a receiving module 108. In variants of the application, a common bidirectional communication module can also be provided.

The at least one receiving module 108 is, in particular, configured to receive a usage request and/or a usage confirmation from a user terminal 136. The usage request comprises at least the requested trip datum. The usage confirmation comprises at least the confirmation data set.

The output module 106 is at least configured to output a current tariff datum determined for the requested trip datum.

The current tariff datum is determined by the dynamic tariff determination module 112. The dynamic tariff determination module 112 is configured to determine a current tariff datum based on at least one tariff criterion and at least one requested trip datum. The current tariff datum differs from a fixed preset tariff datum.

Furthermore, at least one billing module 110 is implemented in the backend system 102. The billing module 110 is configured to bill a trip that has completed, at least based on a received start data set, a received end data set and a fixed preset tariff datum (in a conventional way).

In addition, the billing module 110 is configured, in accordance with the application, to bill the requested trip datum based on the stored trip data set, at least upon a detection of a use of the trip datum stored for the medium identification reference. In variants of the application, two billing modules for the different billing types can be provided.

The storing of the at least one trip data set is executed by a storage module 114. In particular, a trip data set can be stored by the storage module 114 in a data storage 116 of the backend system 102. The trip data set contains at least the current tariff datum, the requested trip datum (with at least one trip datum) and a medium identification reference belonging to the ticket medium with which the user will use the requested trip datum.

In particular, the storing is conducted upon receipt of a confirmation data set in response to the current tariff datum outputted for the requested trip. It is necessary that the response is received within a specific validity period. The validity period (start time is, in particular, the time of output of the current tariff datum) indicates how long the current tariff datum is valid. In particular, if a confirmation data set is received after the validity period has expired, no storing is performed. A message can be sent informing that the current tariff datum is no longer valid. Preferably, this message may also contain a new current tariff datum or a request for a further usage request.

Preferably, the at least one data storage 116 may contain a plurality of user data sets and user accounts, respectively, of registered users and registered medium identification references, respectively. In particular, the billing module 110 can access the stored user data of a user account for the purpose of performing a billing.

In the present embodiment, the backend system 102 comprises at least one assignment module 118 and at least one check module 120. In variants of the application, a common module may be provided.

The assignment module 118 is configured to assign a received end data set to a stored trip data set, based on the medium identification reference contained in each case. In particular, the assignment module 118 executes a corresponding comparison. If it is determined that a received medium identification reference of an end data set (and/or start data set) corresponds to a medium identification reference stored in a trip data set, in particular, is identical, the assignment module 118 assigns the corresponding data sets to each other.

Then the check module 120 checks whether the at least one transport information datum of the assigned end data set (and/or start data set) corresponds to the stored trip datum. This means, in particular, that it is checked whether a location information contained in the end data set or at least derived from it (e.g. from a validator identification or the like), in particular, a destination, corresponds to a location information contained in the trip datum, in particular, a destination. Accordingly, the detection time point of the end data set can be compared with the stored end time point of the requested trip. A start data set can be checked in an analogous way.

Preferably, billing can only be performed with the stored current tariff datum by the billing module 110 if the above-mentioned data correspond to each other.

Optionally, the backend system 102 also comprises a utilization determination module 150, a blocking check module 152 and/or a blocking module 154. The utilization determination module 150 can be configured to determine the predicted and/or actual utilization of a transit vehicle 122.

For example, in the backend system 102, a database with historical utilization data of transit vehicles can be available in at least one data storage 116. Based on the historical utilization data, the utilization determination module 150 can determine the utilization of a transit vehicle 122. AI (artificial intelligence) technology can be used here.

Alternatively or additionally, the utilization determination module 150 can preferably be configured to determine the utilization of a transit vehicle 122 based on the actual start data sets available for this transit vehicle 122, i.e. actual logins made by users. The utilization determination module 150 can know the transport capacity of the transit vehicle 122 (in particular, from a corresponding database of the backend system 102).

Preferably in addition, the determination of the utilization of transit vehicle 122 can be based on the stored trip data sets actually available for this transit vehicle 122.

The blocking check module 152 can be configured to check whether an amount due for the completed trip has been paid within a specific period of time. Alternatively or additionally, the blocking check module 152 can be configured to check, for example, by communicating with a payment service provider of a ticket medium 124, whether the balance of the account assigned to the medium identification reference meets a specific credit criterion (e.g. a specific amount). If it is determined that this is not the case or that the amount has not been paid within a specific period of time, a blocking module 154 may cause a sending of a blocking message to the at least one validator device 126 in such a way that the use of the ticket medium 124 at the at least one validator device 126 is blocked. Otherwise the use remains allowed.

Furthermore, the transit system 100 in the present case comprises a user terminal 136 in the form of a mobile terminal 136 with a communication module 138. The communication module 138 is at least configured to communicate with the output module 106 and the receiving module 108.

Presently, a service application 142 is installed on the mobile terminal 136 (e.g. a smartphone). In the shown example, the service application 142 comprises at least one request module 144 configured to send the described usage request containing at least the requested trip datum. In addition, the service application 142 comprises at least one receiving module 146 configured to receive the described current tariff datum. In addition, at least one confirmation module 148 is presently provided, which is configured to send the usage confirmation containing at least one confirmation data set.

Via a user interface (e.g. touch display or the like), the user can interact with the service application 142, for example, request a current tariff datum for a specific trip that can be specified by the service application 142. The outputted current tariff datum received by the service application 142 can be displayed to the user on a display of the mobile terminal 136 in such a way that the user can confirm acceptance of the displayed current tariff datum by a user action. Upon detection of a corresponding user action, the confirmation module 148 causes, in particular, the sending of a corresponding usage confirmation and confirmation data set, respectively.

As can further be seen, at least one (wireless and/or wired) communication network 140 can be provided to enable communication at least between the shown elements 102, 126, 136.

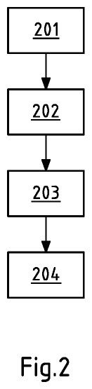

The functionality of the open loop transit system 100, according to FIG. 1, is described in more detail below with the aid of FIG. 2. FIG. 2 shows a diagram of an embodiment of a method according to the present application.

In a step 201, a determining, by the dynamic tariff determination module 112 of the backend system 102, of the current tariff datum occurs based on the requested trip datum and at least one tariff criterion. The tariff criterion is, in particular, a time difference criterion (cf. e.g. table 1) and/or a transport utilization criterion (cf. e.g. table 2) and/or a meteorological criterion (cf. e.g. table 3) and/or an event criterion (cf. e.g. table 4), as described above.

Depending on the at least one tariff criterion and the requested trip datum, i.e., in particular, a requested start time point, end time point, start location and destination location of the requested trip, a current tariff datum is determined, as described above.

In particular, a usage request can be received by the backend system 102 in a previous step. As already described, the request module 144 of a service application 142 can cause a transmission by the communication module 138 of the mobile device 136. In other variants of the application, also a web interface can be provided, over which a usage request can be requested to the dynamic tariff determination module 112.

In a step 202, an outputting, by the output module 108 of the backend system 102, of the current tariff datum occurs determined for the requested trip datum. For example, a corresponding message can be sent to communication module 138 and displayed on a screen of the mobile device 136, e.g. by the service application 142. In other variants of the application, the web interface can output the current tariff datum, in particular, display it on a screen.

In addition, in step 203, a storing, by the storage module 114 of the backend system 102, of a service data set occurs containing the current tariff datum, the requested trip datum and a medium identification reference (which may be contained in the usage request or the confirmation data set or may be determined from a user account (e.g. based on a user ID)).

Storing is done at least upon receipt of a confirmation data set in response to the current tariff datum outputted for the requested trip, as described above. It shall be understood that a part of this data can be stored even during or after the current tariff datum has been outputted and that if no confirmation data set is received within the validity period, this data can be deleted again. Storing a trip data set means, in particular, that this data set was previously confirmed by a confirmation data set.

It shall be also understood that step 202 can be performed several times until the user accepts (or finally rejects) an outputted current tariff datum. For a requested trip, a user can receive periodically updated fares until the user chooses the trip (i.e., accepts a current tariff datum) or discards the requested trip.

In the next step 204, a billing, by the billing module 110 of the backend system 102, of the requested trip datum occurs based on the stored trip data set. The billing is done at least whenever an actual use of the trip datum stored for the medium identification reference is detected.

A detection is performed, in particular, by obtaining and evaluating an end data set which contains a medium identification reference corresponding (in particular, is identical) to the stored medium identification reference and preferably a transport information datum corresponding to the stored trip datum, as described above.

Preferably, the confirmation data set can replace the start data set. In variants of the application, it may be additionally required for a billing with the current tariff datum that also a start data set is received, which contains a medium identification reference corresponding (in particular, is identical) to the stored medium identification reference and preferably a transport information datum corresponding to the stored trip datum.

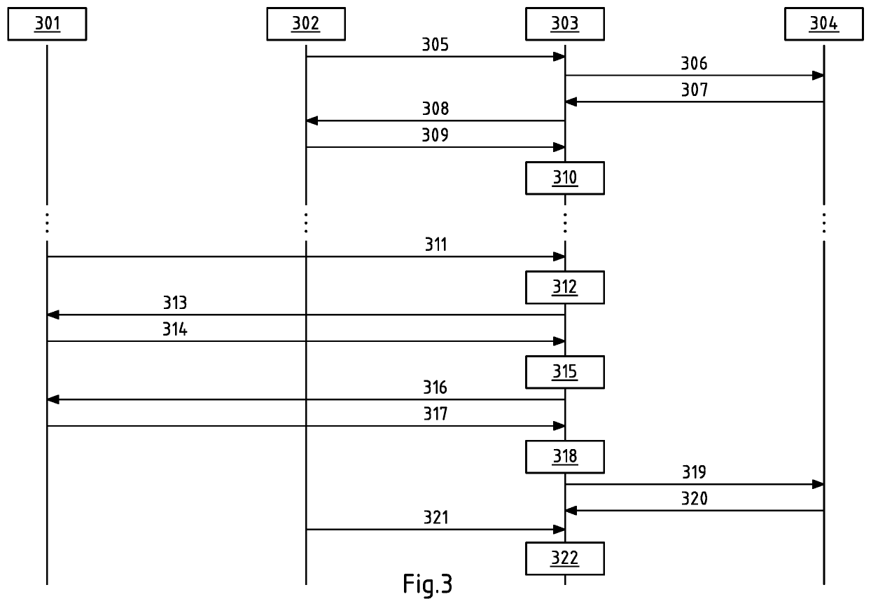

FIG. 3 shows a diagram of a further embodiment of a method according to the present application. The reference number 301 refers to the service application and the mobile terminal, respectively, on which the service application is installed. Reference number 302 refers to the validator device, reference number 303 to the backend system and reference number 304 to a server system of a payment service provider (in particular, the provider of the ticket medium, for example, a credit card).

First of all, FIG. 3 shows an exemplary conventional use of the open loop transit system, as described in the application. The open loop transit system can, for example, be formed as shown in FIG. 1.

After a user logs in at a validator device 302, i.e., in particular, after a detection of the electronic medium identification by the validator device 302, the validator device 302 transmits a start data set in step 305 to the backend system 303. The start data set contains, in particular, the medium identification reference of the detected electronic medium identification, a time stamp of the detection of the electronic medium identification by the validator device 302 and a location information (e.g. geographic coordinates, validator identification, etc.). This data set can be stored in the backend system 303.

Optionally, in step 306, the backend system 303 can inquire the payment service provider 304 whether the account assigned to the received medium identification reference meets at least one specific credit criterion (e.g. a credit limit), as described above.

After a check by the payment service provider 304, it sends the response (criterion fulfilled or not) back to the backend system 303 in step 307. If the criterion is not met, a blocking message can be sent in step 308 to the at least one validator device 302, in particular, in order to block the ticket medium for use in the transit system. If the criterion is met, this step is omitted.

After the user logs off ata (further) validator device 302, i.e. in particular, after the electronic medium identification has been detected by the validator device 302, the validator device 302 transmits an end data set to the backend system 303 in step 309. The end data set contains, in particular, the medium identification reference of the detected electronic medium identification, a time stamp of the detection of the electronic medium identification by the validator device 302 (which may differ from the previous validator device) and a location information (e.g. geographic coordinates, validator identification etc.).

In step 310 (in particular at the end of the day), a billing, by the billing module, of at least one trip performed by the user occurs. Depending on the medium identification reference, the respective start and end data sets belonging to each other can be assigned to each other. Subsequently, a billing data set can be created using the time and/or location information of these data sets as well as a fixed (unchangeable) tariff datum. This can be outputted to the user.

In the following, the method according to the application is described in more detail, in which a dynamic “pricing” takes place in the open loop transit system.

For example, after starting a service application 301 on a user terminal (or after the user terminal accesses a web interface of the backend system 303), a usage request is sent to the backend system 303 in step 311. The usage request contains at least one requested trip datum, i.e., in particular, a start time point, end time point, start location and destination location of the requested trip. It shall be understood that additional or different trip data and/or further or other data (e.g. user identification, medium identification reference, identification of the trip and/or a transit vehicle, etc.) may be included. It shall be further understood that the service application 301 can retrieve timetable data from the backend system 303 (not shown in FIG. 3) in order to generate a usage request.

In step 312, the dynamic tariff determination module of the backend system 303 determines a current tariff datum, in particular, based on the data content of the received usage request and at least one tariff criterion (cf. e.g. the description to tables 1, 2, 3 and/or 4).

In step 313, the specific current tariff datum is outputted by transmitting it to the requesting user terminal and service application 301, respectively. A timer can be started at the same time. Thus, the current tariff datum is only valid for a specific period of time. After this (validity) period, i.e. after the timer has expired, the current tariff datum is invalid. For example, a new usage request can then be sent to initiate a new determination.

If the user does not agree with the received current tariff datum, the user can (e.g. after a specific period of time) submit a new usage request (step 314). Then (step 315), a current tariff datum can be determined again, as described above.

This may be different from the previous current tariff datum, for example, due to a change in the utilization determined by a utilization determination module and/or a change in the predicted meteorological condition and/or a change in the date of the requested trip (e.g. different times).

In step 316, an outputting of the determined current tariff datum takes place in an analogous way to step 313.

The service application 301 can also be configured to periodically and automatically submit a new usage request with the same trip datum (step 314) as before, so that a new current tariff datum is periodically determined for a usage request submitted by the user (step 315) and outputted to service application 301 (step 316) until the user accepts the current tariff datum received or rejects the request. Alternatively, the backend system 303 can be configured to automatically determine a new current tariff datum periodically (step 315) and output it to the service application 301 (step 316) until the user accepts the received current tariff datum or rejects the request.

If the user accepts the received current tariff datum, he can confirm it by a user action. If a corresponding user action is detected, the service application 301 causes transmitting of a confirmation data set (step 317), which at least indicates that the outputted current tariff datum is accepted for the requested trip. It goes without saying that additional or other data (e.g. user identification, medium identification reference, etc.) may be included.

Assuming that the validity period has not yet expired, in step 318, a storing takes place, by the backend system 303, of a trip data set containing at least the requested trip datum, the medium identification reference (with which the requested trip is to be used) and the confirmed current tariff datum.

Optionally, the backend system 303 can send to the server system 304 an authorization request about the stored current tariff datum (step 319) to effect a payment authorization of the amount due for the use according to the current tariff datum. This can be done, in particular, if a specific limit amount (e.g. 50 €) is exceeded.

After a payment authorization, the server system 304 sends a corresponding confirmation to the backend system 303 in step 320. It shall be understood that an authorization request can also be made before the corresponding trip data set is stored. In particular, it shall be understood that the process can be cancelled if an authorization fails.

In this embodiment, the confirmation data set preferably replaces the start data set. In other variants of the application, a start data set can also be taken into account and, in particular, a corresponding log in (“check-in”) at a validator device can be detected and evaluated.

In step 321, the validator device 302 transmits an end data set to the backend system 303 after the user has logged off (“check-out”) at the validator device 302, i.e., in particular, after the electronic medium identification has been detected by the validator device 302. The end data set contains, in particular, the medium identification reference of the detected electronic medium identification, a time stamp of the detection of the electronic medium identification by the validator device 302 (which may differ from the previous validator device) and a location information of the validator device 302 (e.g. geographic coordinates, validator identification etc.).

In step 322, at first an assigning occurs of the received end data set to a stored trip data set based on the medium identification reference. After a check by a check module on the basis of the received and stored data whether the trip was completed as requested by the user, a billing is made if the test result is positive, i.e. if it is determined that the trip was completed as requested by the user. The billing module of the backend system 303, in particular, executes a billing of the requested trip datum based on the stored trip data set, i.e., in particular, the stored current tariff datum.

If a deviation is found during the check (for example, in the destination location and/or end time point), a billing can be made according to at least one specific rule.

For example, the rule can specify that billing must then be performed according to the fixed preset tariff datum.

It goes without saying that some of the described steps can also be performed in a different order or at least partly in parallel.

In principle, the dynamic “pricing” method according to the application can also be applied to a transit system in which a paid area does not include a validator device, but rather a determination of whether a user is within a paid area occurs (exclusively) using the mobile device (or its sensors (GPS sensor, Bluetooth sensor, acceleration sensor, etc.)).

What is claimed is:

1. A backend system (102, 303) of an open loop transit system (100), comprising:
at least one billing module (110) configured to bill a completed trip at least based on a received start data set, a received end data set and a fixed preset tariff datum, wherein the start data set and the end data set each contains the same medium identification reference determined from the electronic medium identification of a ticket medium (124) detected by at least one validator device (126, 302) of the transit system (100) and at least one transport information datum;
at least one dynamic tariff determination module (112) configured to determine a current tariff datum based on a requested trip datum and at least one tariff criterion, wherein the current tariff datum differs from the fixed preset tariff datum;
at least one output module (106) configured to output a current tariff datum determined for the requested trip datum; and
at least one storage module (114) configured to store a trip data set containing the requested trip datum, the outputted current tariff datum and a medium identification reference, upon receipt of a confirmation data set in response to the outputted current tariff datum for the requested trip datum, wherein the billing module (110) is configured to bill the requested trip datum, based on the stored trip data set at least upon detection of a use of the trip datum stored for the medium identification reference.

2. The backend system according to claim 1, wherein
at least one transport information datum is selected from the group, comprising:
a time stamp of the detection of the electronic medium identification by
the validator device (126, 302),
an identification of the validator device (126, 302),
a location of the validator device (126, 302),
an identification of a transit vehicle (122),
an identification of a transit station (122), and/or
the requested trip datum includes at least one trip datum selected from the group, comprising:
a start location of the requested trip,
a destination location of the requested trip,
a calendar date of the requested trip,
a start time point of the requested trip,
an end time point of the requested trip,
an identification assigned to a requested transit vehicle.

3. The backend system according to claim 1, further comprising:
at least one receiving module (108) configured to receive a usage request from a user terminal (136), wherein the usage request comprises at least the requested trip datum,
and/or to receiving a usage confirmation from a user terminal (136), comprising the confirmation data set.

4. The backend system according to claim 1, wherein the medium identification reference is a medium identification reference registered in the backend system,
wherein a registered medium identification reference is stored in a user data set in the backend system,
wherein the user data set comprises, in particular, at least one further user datum selected from the group, comprising
a user name,
address data of the user,
a user password,
billing data,
trip tariff data,
billing details,
data of other payment media,
a membership to a user group.

5. The backend system according to claim 1 further comprising:
at least one assignment module (118) configured to assign a received end data set to a stored trip data set based on the respectively contained medium identification reference, and
at least one check module (120) configured to check whether the at least one transport information datum of the end data set corresponds to the stored trip datum of the trip data set.

6. The backend system according to claim 5, wherein the billing module (110) is configured to bill the requested trip datum, based on the stored current tariff datum, only if the check module (120) determines that the at least one transport information datum corresponds to the stored trip datum.

7. The backend system according to claim 1, wherein the confirmation data set replaces the start data set.

8. The backend system according to claim 1, wherein the at least one tariff criterion is a time difference criterion, which indicates a dependency between a time difference and the current tariff datum,
where the time difference is, in particular, the time difference between the time point of receipt of a usage request and a start time point of the requested trip datum.

9. The backend system according to claim 1, wherein the at least one tariff criterion is a transport utilization criterion, and wherein the transport utilization criterion indicates a dependency between a transport utilization of at least one transit vehicle of a requested trip datum and the current tariff datum.

10. The backend system according to claim 1, wherein the at least one tariff criterion is at least one meteorological criterion.

11. The backend system according to claim 1, wherein the at least one tariff criterion is at least one event criterion.

12. The backend system according to claim 1, further comprising:
at least one blocking check module (152) configured to check whether an amount payable for the completed trip has been paid within a specific period of time, and
at least one blocking module (154) configured to send a blocking message to the at least one validator device (126, 302) such that the use of the ticket medium (124) at the at least one validator device (126, 302) is blocked.

13. An open loop transit system (100), comprising:
at least one backend system according to claim 1, and
at least one validator device (126, 302) configured to detect an electronic start data set and/or end data set of a ticket medium (124) used for a trip.

14. The open loop transit system according to claim 13, further comprising:
at least one service application (142, 301) installable on a user terminal (136),
wherein the service application (142, 301) comprises at least one request module (144) configured to cause a sending of a usage request containing at least one requested trip datum,
and/or
wherein the service application (142, 301) comprises at least one receiving module (146) configured to receive an instantaneous tariff datum determined for the requested trip datum,
and/or
wherein the service application (142, 301) comprises at least a confirmation module (148) configured to cause a sending of a usage confirmation containing at least one confirmation data set.

15. A method for operating an open loop transit system comprising a backend system, the method comprising:
determining, by a dynamic tariff determination module of the backend system, a current tariff datum based on a requested trip datum and on at least one tariff criterion;
outputting, by at least one output module of the backend system, of the current tariff datum determined for the requested trip datum;
upon receipt of the confirmation data set in response to the current tariff datum outputted for the requested trip datum: storing, by at least one storage module (114) of the backend system, a trip data set containing the outputted current tariff datum, the requested trip datum and a medium identification reference; and
upon detection of a use of the trip datum stored for the medium identification reference: billing, by a billing module (110) of the backend system, of the requested trip datum, based on the stored trip data set.
